(19) United States
(12) Patent Application Publication
(10) Pub. No.: US 2011/0103877 A1
(43) Pub. Date: May 5, 2011

(54) Pen with Rotating Ornaments

(76) Inventor: Yu-Yin LIU, Taipei (TW)

(21) Appl. No.: 12/176,346

(22) Filed: Jul. 19, 2008

(51) Int. Cl. B43K 29/00; B43K 29/007

(52) U.S. Cl. 401/195

(57) ABSTRACT

A pen with rotating ornaments is disclosed. The pen includes a pen tube with a power supply therein, a motor whose one end is arranged with a wire connected with the power supply while at least an end is disposed with a shaft that connects with an ornament. The ornament is arranged with figures, words or advertisement. By the voltage from the power supply, the motor rotates so that the shaft rotates and drives the ornament to rotate. Thus by the rotated ornament through transparent pen tube, the interest senses, decorative effects and advertising effect of the pens are improved.

### BACKGROUND OF THE INVENTION

The present invention relates to a pen with rotating ornaments, especially to a pen disposed with a power supply and a motor in a pen tube thereof. The motor is connected to the power supply while at least an end is disposed with a rotating shaft that is joined with at least one ornament so that the ornament is driven to rotate with more interesting senses and decorative effects.

Pen is one of the most useful and portable daily necessities. Moreover, the pen design is not only for writing but also for interesting senses, decoration or advertisement. For example, refer to Taiwanese Pub. No. M312434, a display panel is pulled out or retracted into a vertical slot on a pen tube elastically. Refer to Taiwanese Pub. No. 563636, a hollow pen tube is mounted with a transparent plate. By a light emitting device therein, words or figures on the transparent plate are displayed. Refer to Taiwanese Pub. No. 329756, a mounting slot is disposed on rear end of the pen for accommodation of advertising board, photos or figures so as to display the advertisement. Or a multi-function pen includes a vibrating motor connected with a massage device for providing massage function while an advertisement is attached or printed on surface of the pen so as to achieve double effects—massage and advertising. However, most of advertising device is static so that the advertising effect is insufficient and lack of decorative effects or interesting senses. They can't match users' requirements. Thus there is a need to provide a new pen that overcomes above shortcomings.

### SUMMARY OF THE INVENTION

Therefore it is a primary object of the present invention to provide a pen with rotating ornaments that includes a pen tube, a motor, an ornament and a power supply. The power supply makes the motor drive the motor shaft rotating synchronously. The pen of the present invention includes the power supply and the motor disposed inside the pen tube. The motor is arranged with a wire connected with the power supply while at least an end is disposed with a rotating shaft that connects with the ornament. Thereby, when the power supply applies a voltage to the motor, the motor rotates for driving shaft rotating and further drives the ornament to rotate. Therefore, the interest senses, aesthetics and advertising effect of the pen are all enhanced.

It is another object of the present invention to a pen with rotating ornaments that the at least one ornament is disposed with figures or words so as to increase interest senses and advertising effect.

It is a further object of the present invention to a pen with rotating ornaments that the power supply inside the pen gets the power from a solar cell so as to save energy and achieve environmental protection.

### BRIEF DESCRIPTION OF THE DRAWINGS

FIG. 1 is a perspective view of an embodiment according to the present invention;

FIG. 2 is a cross-sectional view of the embodiment in FIG. 1;

FIG. 3 is a perspective view of another embodiment according to the present invention;

FIG. 4 is a perspective view of another embodiment according to the present invention;

FIG. 5 is a perspective view of a further embodiment according to the present invention;

FIG. 6 is a perspective view of a further embodiment according to the present invention;

FIG. 7 is a cross-sectional view of the embodiment in FIG. 6;

FIG. 8 is a cross-sectional view of the embodiment in FIG. 6 added with an accumulator;

FIG. 9 is a perspective view of a further embodiment according to the present invention;

FIG. 10 is a cross-sectional view of the embodiment in FIG. 9;

FIG. 11 is a cross-sectional view of the resistor and dual rotating shaft according to the present invention.

### DETAILED DESCRIPTION OF THE PREFERRED EMBODIMENT

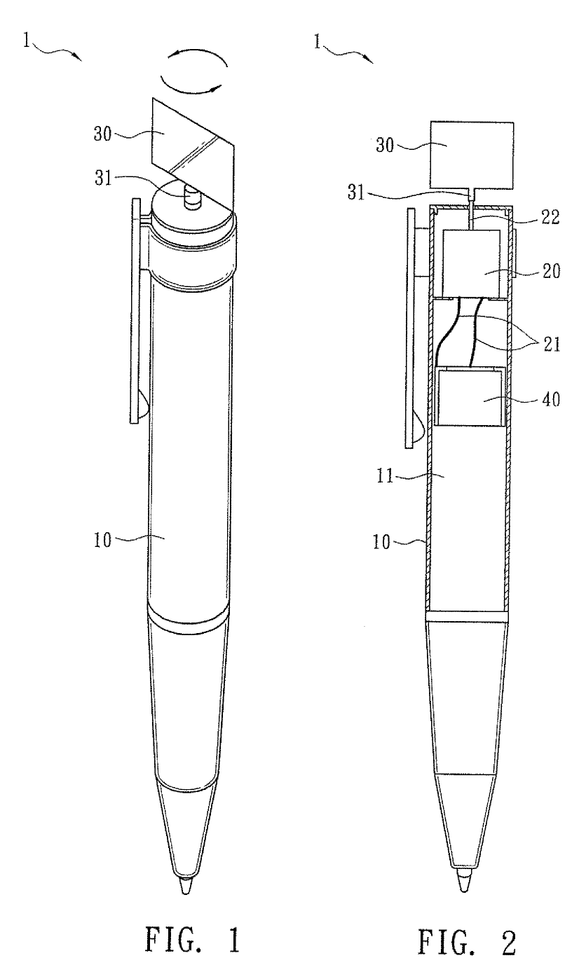

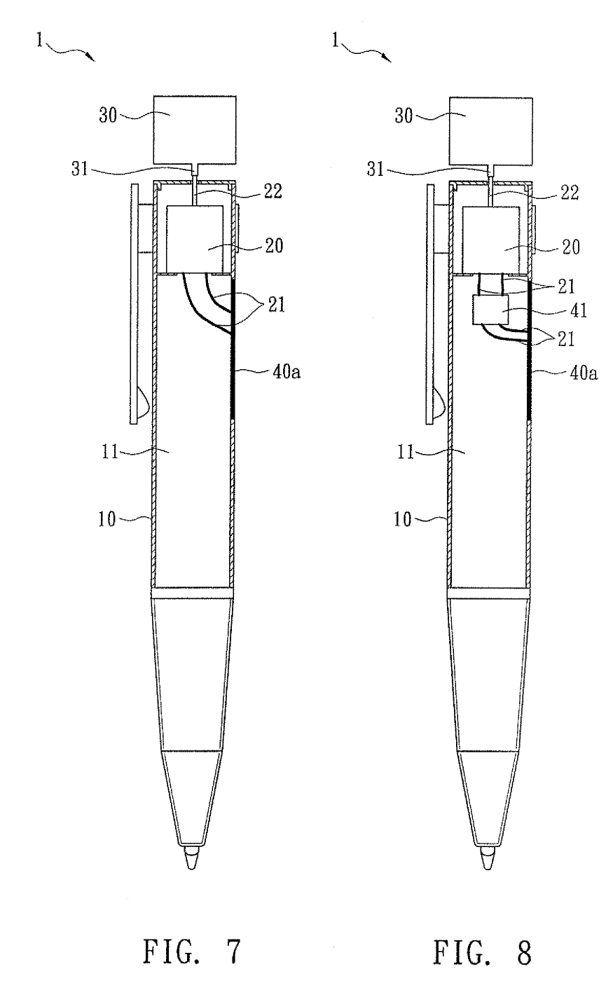

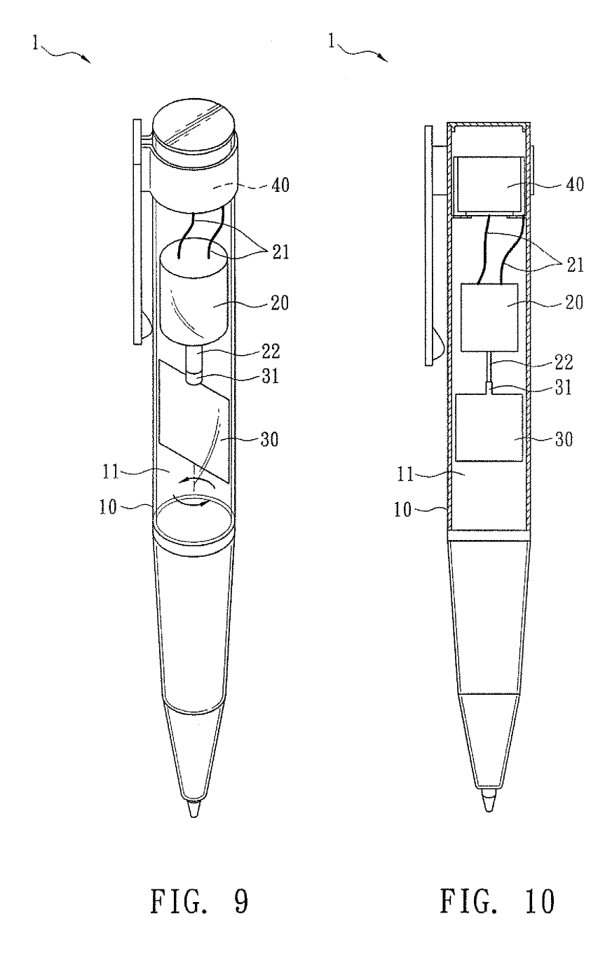

Refer to FIG. 1 & FIG. 2, a pen 1 of the present invention consists of a pen tube 10, a motor 20, an ornament 30, and a power supply 40. The material and the shape of the pen tube 10 is not limited. It can be transparent, as shown in FIG. 9, transparent window or opaque, round or polygon (not shown in figure). The motor 20 is a mini motor disposed inside the pen tube 10. The shape of the ornament 30 is not restricted and it can be a vertical plate, horizontal plate, or three-dimensional object. The power supply 40 can be various types such as button cell (as shown in FIG. 2), solar cell (as shown in FIG. 6, FIG. 7 & FIG. 8), battery, paper battery or liquid battery,.

The present invention features on that a space 11 is inside the pen tube 10. From bottom to top or form top to bottom, the space 11 is disposed with a power supply 40, and a motor 20. The motor 20 has a wire 21 connected to the power supply 40 while at least an end thereof is disposed with a rotating shaft 22 that is joined with a connection part 31 of an ornament 30. Thereby, when the power supply 40 applies a voltage to the motor 20, the rotating shaft 22 of the motor 20 rotates and further drives the ornament 30 to rotate. Therefore, the interest senses, decorative effect and advertising effect of the pen 1 are improved by rotation of the ornament 30.

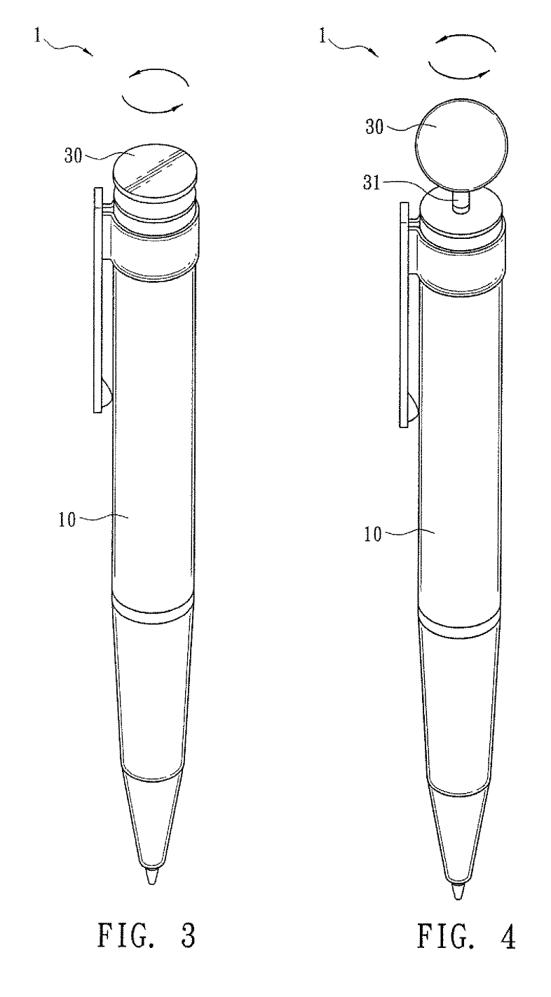

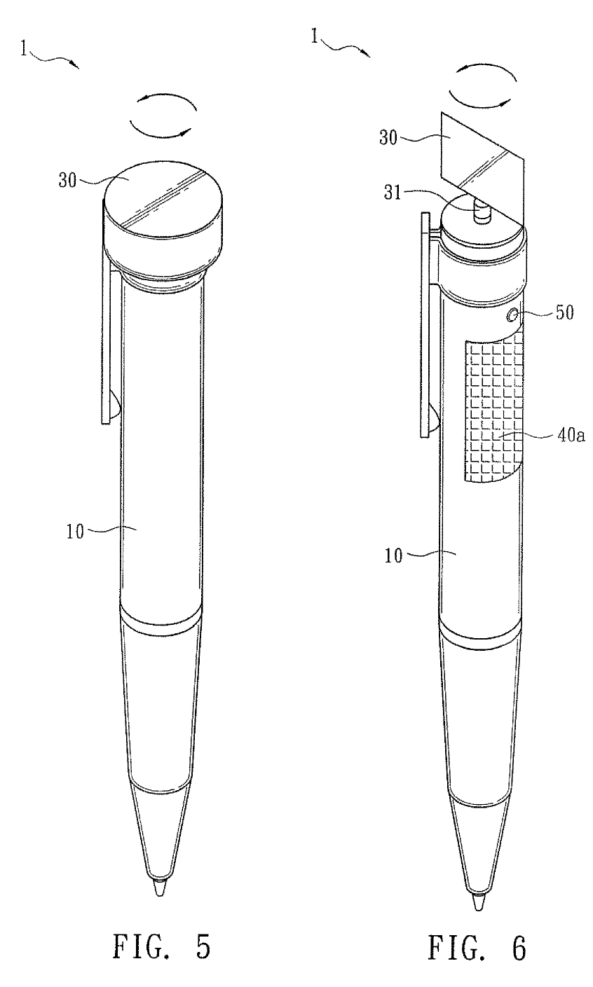

Refer to FIG. 1, FIG. 3, FIG. 4 & FIG. 5, the rotating shaft 22 is joined with the connection part 31 of the ornament 30 and the ornament 30 changes according to users' requirements. As shown in FIG. 1 the ornament 30 is a vertical plate whose shape is not limited. It can be round or rectangular (not shown in figure). Refer to FIG. 4, it can be a three-dimensional object such as a ball, a cylinder, a pyramid, various animal form or cartoon characters (not shown in figure). Or as shown in FIG. 5, it looks like a hat, a beret or variety of hats (not shown in figure). Moreover, on the ornament 30, users can arrange figure or words they need. Thus when the motor 20 drives the ornament 30 to rotate, the ornament 30 rotates and shows dynamic effect so as to improve interest senses, decorative effect and advertising effect of the pen 1.

Refer to FIG. 6, FIG. 7 & FIG. 8, the pen tube 10 is arranged with a solar chip 40a that collects solar energy. Through the wire 21, the solar chip 40a provides the motor 20 power for driving the motor 20 to rotate and further the ornament 30 is driven to rotate, as shown in FIG. 7. Furthermore, the space 11 is inside the pen tube 10 is further disposed with an accumulator 41. The accumulator 41 is a capacitor that saves power. When there is no sufficient light projected on the solar chip 40a and the power generated is not enough to drive the motor 20, the power saved in the accumulator 41 is used to drive the motor 20 and ornament 30 to rotate. Thus charging capability and lifetime of the solar chip 40a are extended. Moreover, the pen tube 10 of the pen 1 is arranged with a switch 50 so as to turn on or turn off the motor 20 and further control rotation of the ornament 30.

Refer to FIG. 9 & FIG. 10, the pens tube 10 is made from transparent material, while the ornament 30 is arranged inside the pens tube 10, so that the rotated ornament 30 is displayed through the transparent pen tube 10. Thus the interest senses, decorative effect and advertising effect of the pen 1 are increased.

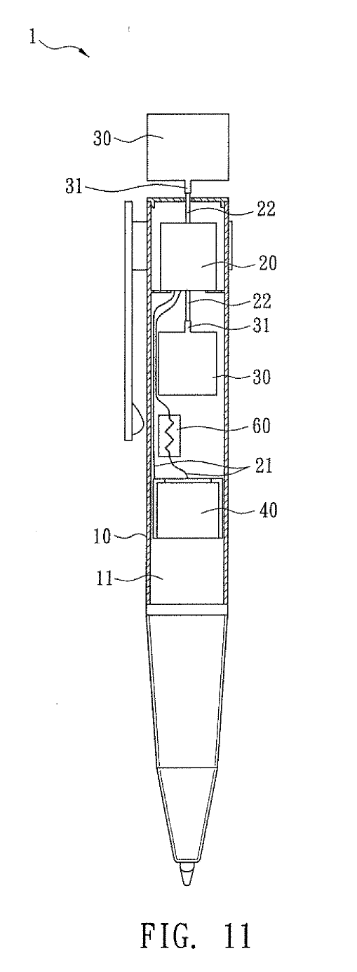

Refer to FIG. 11, the power supply 40 is connected with the resistor through a wire 21 for controlling the rotating speed of rotating shaft 22 and the ornament 30 thereon. Furthermore, the motor 20 of the pen 1 can be designed to be a dual-shafted motor so as to have one rotating shaft 22 on each end of the motor. Thereby the rotating shaft 22 arranged on each end of motor 20 can be connected with the ornament 30 respectively. For example, the ornaments can be displayed inside and outside of the pens tube 10, thus two ornaments are rotated synchronously while the motor 20 rotates. Thus, the interest senses, decorative effect and advertising effect of the pen 1 are increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A pen with rotating ornaments comprising a pen tube, a motor, a power supply, ornaments; wherein
the pen tube has a space for containing a power supply and a motor;
the motor by voltage provided from the power supply rotates and drives at least a rotating shaft to rotate; and
the ornament is arranged on the end of rotating shaft of the motor;
wherein, the power supply applied the voltage to the motor drives the motor shaft rotating and further the ornament rotating.

2. The device as claimed in claim 1, wherein the motor of the pen is arranged dual rotating shaft; the rotating shaft is disposed on each end of motor, so as to connect with ornament respectively.

3. The device as claimed in claim 2, wherein the ornaments connected with rotating shaft on the both ends of motor are displayed inside and outside of the pens tube.

4. The device as claimed in claim 1, wherein the power supply is selected from the group of battery, button cell, paper battery, liquid battery, and solar cell.

5. The device as claimed in claim 4, wherein an accumulator is arranged for the solar cell operation.

6. The device as claimed in claim 1, wherein the space of the pen tube is disposed with a power supply and a motor from bottom to top.

7. The device as claimed in claim 1, wherein the space of the pen tube is disposed with a power supply and a motor from top to bottom.

8. The device as claimed in claim 1, wherein the ornament is disposed with labels with figures, images, words or advertisements.

9. The device as claimed in claim 1, wherein the pen tube of the pen is arranged with a switch for control of on/off of the motor.

10. The device as claimed in claim 1, wherein the power supply is connected with resistor for controlling the rotating speed of rotating shaft.

11. The device as claimed in claim 1, wherein the pen tube is made from transparent material.

12. The device as claimed in claim 1, wherein the pen tube of the pen is arranged with a transparent window.
